(19) United States
(12) Patent Application Publication
(10) Pub. No.: US 2020/0387670 A1
(43) Pub. Date: Dec. 10, 2020

(54) LABELING DEVICE, LABELING METHOD, AND PROGRAM

(71) Applicant: Kyushu Institute of Technology, Kitakyushu-shi, Fukuoka (JP)

(72) Inventor: Sozo Inoue, Kitakyushu-shi, Fukuoka (JP)

(21) Appl. No.: 16/959,596

(22) PCT Filed: Dec. 28, 2018
(86) PCT No.: PCT/JP2018/048551

§ 371 Date: Jul. 1, 2020

(30) Foreign Application Priority Data
Jan. 5, 2018 (JP) 2018-000806

(51) Int. Cl. G06F 40/284; G06K 9/62; G06N 20/00

(52) U.S. Cl. CPC G06F 40/284; G06K 9/6232; G06N 20/00; G06K 9/6259

(57) ABSTRACT

Provided is a labeling device for teacher data used in learning during machine learning for estimating a time series of actions from data detected by a sensor. The labeling device includes a keyword extraction unit that extracts, as teacher label candidates which are candidates for teacher labels, action keywords indicating the actions included in text data in which the actions are recorded in a natural language text format; and a selection unit that selects the teacher labels corresponding to time information indicating candidates for times at which the actions are performed from the candidates for the teacher labels extracted by the keyword extraction unit.

### TECHNICAL FIELD

The present invention relates to a labeling device, a labeling method, and a program.

Priority is claimed on Japanese Patent Application No. 2018-000806, filed Jan. 5, 2018, the content of which is incorporated herein by reference.

### BACKGROUND ART

An action recognition technology for estimating actions of a person from data acquired by a sensor worn by the person or sensor data acquired by a sensor measuring an environment is known. In virtue of the action recognition technology, automatic recording and visualization of work, and improvement of work through feedback of actions can be achieved by estimating the actions of a person. In addition, it is conceivable that data acquired from a sensor or the like and other data such as results of work be combined to be useful for improvement of work.

Supervised learning (a branch of machine learning) is used in action recognition using time series data as well as a sensor. In supervised learning, a learning model is generated using teacher data. Teacher data is data in which a teacher label (information indicating an actual action) and a feature amount extracted from data acquired from a sensor are combined. In supervised learning, a teacher label indicating an action is estimated from a feature amount extracted from data acquired from a sensor on the basis of a generated learning model.

Regarding a technology for estimating actions of a person using such supervised learning, for example, an information processing device that provides information by combining results of action pattern recognition on the basis of information acquired from a position sensor or a motion sensor and information other than the information acquired from the position sensor or the motion sensor is known (Patent Literature 1). In the information processing device disclosed in Patent Literature 1, text information and time information having the text information input thereto are acquired, acquired text is analyzed, and information related to experiences of a user is extracted from the text information. In the information processing device disclosed in Patent Literature 1, when information related to experiences of a user is obtained, a kind feature amount is extracted from text information, and the kinds of experiences are identified from the input kind feature amount utilizing a learning model on the basis of the extracted kind feature amount.

### CITATION LIST

### Patent Literature

[Patent Literature 1]

Japanese Unexamined Patent Application, First Publication No. 2013-250861

### SUMMARY OF INVENTION

### Technical Problem

However, a machine learning algorithm is used in such a technology for the information processing device disclosed in Patent Literature 1. Therefore, there is a need to prepare teacher data in order to generate a learning model. In order to prepare teacher data a feature amount has to be extracted from data acquired from a sensor, and labeling with a teacher label corresponding to the extracted feature amount has to be performed. Since labeling (annotation) with a teacher label is performed by a person, labor and time are required to select a teacher label corresponding to a feature amount, which is burdensome. For this reason, a sufficient amount of teacher data may not be able to be collected, and thus it may be difficult to perform highly accurate action recognition.

The present invention has been made in consideration of the foregoing matter and provides a labeling device, a labeling method, and a program capable of simply performing labeling of teacher data used in learning during machine learning with a teacher label.

### Solution to Problem

The present invention has been made in order to resolve the foregoing problem. According to an aspect of the present invention, there is provided a labeling device (1) for teacher data (TD) used in learning during machine learning for estimating a time series of actions from data detected by a sensor. The labeling device includes a keyword extraction unit (10) that extracts, as teacher label candidates (LC) which are candidates for teacher labels, action keywords (KA) indicating the actions included in text data (TX) in which the actions are recorded in a natural language text format; and a selection unit (14) that selects the teacher labels (LL) corresponding to time information (TI) indicating candidates for times at which the actions are performed from the teacher label candidates (LC) extracted by the keyword extraction unit (10).

In addition, according to the aspect of the present invention, in the labeling device, the keyword extraction unit extracts the time information from the text data.

In addition, according to the aspect of the present invention, in the labeling device, when there are a plurality of the teacher label candidates for one of the actions regarding the extracted teacher label candidates, the keyword extraction unit extracts the teacher label candidates fewer than the plurality of the teacher label candidates.

In addition, according to the aspect of the present invention, in the labeling device, the keyword extraction unit extracts the teacher label candidates using any of techniques including morphological analysis, dependency analysis, and case frame analysis.

In addition, according to the aspect of the present invention, in the labeling device, the selection unit selects the teacher labels from the teacher label candidates extracted by the keyword extraction unit using supervised learning.

In addition, according to another aspect of the present invention, there is provided a labeling method for teacher data used in learning during machine learning for estimating a time series of actions from data detected by a sensor. The labeling method includes a keyword extracting process of extracting, as teacher label candidates which are candidates for teacher labels, action keywords indicating the actions included in text data in which the actions are recorded in a natural language text format; and a selecting process of selecting the teacher labels corresponding to time information indicating candidates for times at which the actions are performed from the teacher label candidates extracted in the keyword extracting process.

In addition, according to another aspect of the present invention, there is provided a program for causing a computer, which performs labeling of teacher data used in learning during machine learning for estimating a time series of actions from data detected by a sensor, to execute a keyword extracting step of extracting, as teacher label candidates which are candidates for teacher labels, action keywords indicating the actions included in text data in which the actions are recorded in a natural language text format; and a selecting step of selecting the teacher labels corresponding to time information indicating candidates for times at which the actions are performed from the teacher label candidates extracted in the keyword extracting step.

### Advantageous Effects of Invention

According to the present invention, it is possible to simply perform labeling of teacher data used in learning during machine learning with a teacher label.

### BRIEF DESCRIPTION OF DRAWINGS

FIG. 1 is a view showing an overview of action recognition performed through machine learning using a labeling device according to an embodiment of the present invention.

FIG. 2 is a view showing an example of a configuration of the labeling device according to the embodiment of the present invention.

FIG. 3 is a view showing an example of learning processing of the labeling device according to the embodiment of the present invention.

FIG. 4 is a view showing an example of processing of generating teacher data of the labeling device according to the embodiment of the present invention.

FIG. 5 is a view showing an example of text data according to the embodiment of the present invention.

FIG. 6 is a view showing an example of a segment according to the embodiment of the present invention.

FIG. 7 is a view showing an example of an overview of processing of selecting a teacher label candidate of a selection unit according to the embodiment of the present invention.

FIG. 8 is a view showing an example of estimation processing of an action estimation device according to the embodiment of the present invention.

### DESCRIPTION OF EMBODIMENT

### Embodiment

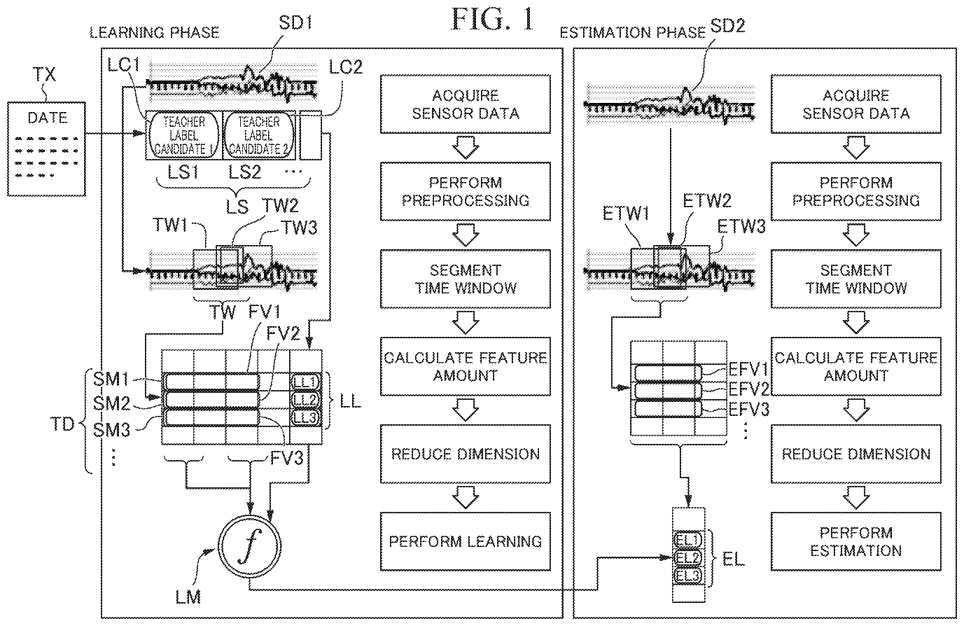

Hereinafter, an embodiment of the present invention will be described in detail with reference to the drawings. FIG. 1 is a view showing an overview of action recognition performed through machine learning using a labeling device 1 according to the present embodiment. In action recognition performed through this machine learning, a time series of actions of a subject is estimated. Action recognition performed through machine learning using the labeling device 1 includes a learning phase and an estimation phase.

In the learning phase, teacher data TD is generated, and a learning model LM is generated through machine learning using the generated teacher data TD. The labeling device 1 of the present embodiment generates this teacher data TD.

The teacher data TD is a set of a feature amount vector FV extracted from sensor data SD1 and a teacher label LL. Here, the teacher label LL is a keyword indicating an action of a subject. The teacher label LL is a keyword indicating an action of a subject, such as “ate”, “restroom”, “took medicine”, “took a dose of a tablet”, “took a dose”, “took a walk”, or “ran”, for example. The sensor data SD1 is time series data in which values measured by a sensor measuring motions or postures of a subject are enumerated in the order of times at which the values are measured.

For example, a sensor is a sensor acquiring biological information of a subject, an accelerometer detecting a body motion of a subject, or the like. Values measured by a sensor include a heart rate of a subject, and an acceleration of a part of a body to which a sensor is attached. This sensor may be provided on the body of a subject or may be installed around a subject. In a case of being installed around a subject, the sensor may measure motions or postures of the subject through image analysis of an image of the subject captured by a camera installed around the subject. The sensor may be an environment sensor. When the sensor is an environment sensor, it may measure environmental data such as a brightness, a room temperature, an air temperature, and a humidity around a subject. In addition, the sensor may be a motion detecting sensor. However, when the sensor is installed around a subject, the sensor can identify that data to be measured is data related to the subject. For example, the sensor can distinguish motions or postures of a subject from motions or postures of a person other than the subject. In addition, regarding environmental data, the sensor can distinguish environmental data of a residence of a subject from environmental data of other places.

An action keyword KA is extracted as a teacher label candidate LC through natural language processing from text data TX in which actions of a subject are recorded using a natural language text format, and the teacher label LL is generated from the extracted teacher label candidate LC. Here, the action keyword KA is a keyword indicating an action of a subject. The teacher label candidate LC is a candidate for the teacher label LL. That is, a keyword indicating an action of a subject is extracted as a candidate for the teacher label LL. For example, the text data TX is data describing a daily record of work in which the circumstances of nursing a subject in a nursing facility are recorded.

The time information TI, indicating a candidate for a time at which an action of a subject is performed, is extracted together with the teacher label candidate LC from the text data TX in which actions of the subject are recorded. Here, the time information TI includes beginning time information BT indicating a candidate for a beginning time, and ending time information ET indicating a candidate for an ending time. A label segment LS is generated from the teacher label candidate LC, and the beginning time information BT and the ending time information ET of an action of a subject. Here, the label segment LS is a set of the teacher label candidate LC, and the beginning time information BT and the ending time information ET. Hereinafter, a time section from a candidate for a beginning time of an action of a subject indicated by the beginning time information BT to a candidate for an ending time of an action of a subject indicated by the ending time information ET will be referred to as a time section IN of the label segment LS. In addition, a beginning time of an action indicated by the beginning time information BT included in the label segment LS is sometimes referred to as a beginning time of the label segment LS, or the like. An ending time of an action indicated by the ending time information ET included in the label segment LS is sometimes referred to as a beginning time of the label segment LS, or the like.

The feature amount vector FV is a vector in which one or more feature amounts extracted from the sensor data SD1 are enumerated. Feature amounts of the sensor data SD1 include the average of values, a standard deviation, a largest value, a smallest value, and a rate of increase of data at certain time intervals; an average value of first derivative values; or the like. Hereinafter, a time interval will be referred to as a time window TW. One or more extracted feature amounts configure the feature amount vector FV at a time indicated by the median value of the time window TW.

The size of the time window TW may be set in advance on the basis of the number of seconds or the like or may be set as a size suitable for extracting a feature amount. The intervals between the time windows TW may be set in advance using the number of seconds or the like or may be set as intervals suitable for extracting a feature amount.

In the example shown in FIG. 1, one or more feature amounts in a time window TW1 are extracted as a feature amount vector FV1 at a time indicated based on the median value of the time window TW1. One or more feature amounts in a time window TW2 are extracted as a feature amount vector FV2 at a time indicated based on the median value of the time window TW2. One or more feature amounts in a time window TW3 are extracted as a feature amount vector FV3 at a time indicated based on the median value of the time window TW3. However, in the example shown in FIG. 1, only the time window TW1 to the time window TW3 are shown, but feature amount vectors corresponding to time windows other than the time window TW1 to the time window TW3 are also extracted.

In the example shown in FIG. 1, one or more label segments including a label segment LS1, a label segment LS2, and so on are generated from the text data TX in which actions of a subject corresponding to times indicated by the sensor data SD1 are recorded. However, in the example shown in FIG. 1, only the label segment LS1 and the label segment LS2 are shown, but label segments LSi (i=3, 4, and so on) other than the label segment LS1 and the label segment LS2 are also generated.

A sample SM1, a sample SM2, a sample SM3, and so on are generated using supervised learning from the feature amount vector FV1, the feature amount vector FV2, the feature amount vector FV3, and so on which have been extracted and the label segment LS1, the label segment LS2, and so on which have been generated. Here, a sample is a set of the feature amount vector FV at a certain time and the teacher label LL at this time. For example, the sample SM1 is a set of the feature amount vector FV1 and a teacher label LL1.

Here, the number of feature amount vectors including the feature amount vector FV1, the feature amount vector FV2, the feature amount vector FV3, and so on generally differs from the number of label segments including the label segment LS1, the label segment LS2, and so on. In addition, times respectively corresponding to the feature amount vector FV1, the feature amount vector FV2, the feature amount vector FV3, and so on do not necessarily correspond to a time section IN1 of the label segment LS1, a time section IN2 of the label segment LS2, and so on. The teacher label LL1, a teacher label LL2, a teacher label LL3, and so on respectively corresponding to the feature amount vector FV1, the feature amount vector FV2, the feature amount vector FV3, and so on are determined through supervised learning from the feature amount vector FV1, the feature amount vector FV2, the feature amount vector FV3, and so on, and the label segment LS1, the label segment LS2, and so on. This supervised learning will be described below in detail.

The sample SM1, the sample SM2, the sample SM3, and so on which have been generated become the teacher data TD. The learning model LM is generated through machine learning using the teacher data TD. The learning model LM is a function for outputting a keyword indicating an action of a subject indicated by the sensor data SD1 when a certain feature amount vector FVj extracted from the sensor data SD1 is input.

In the estimation phase, an action of a subject is estimated from sensor data SD2 using the learning model LM learned in the learning phase. In the estimation phase, differing from the learning phase, an estimation label EL is estimated from the sensor data SD2 on the basis of the learning model LM without using the text data TX in which actions of a subject corresponding to times indicated by the sensor data SD2 are recorded. The estimation label EL is a keyword indicating an action of a subject corresponding to a time indicated by the sensor data SD2.

A feature amount vector EFV1 corresponding to a time window ETW1 is generated from the sensor data SD2. A feature amount vector EFV2 corresponding to a time window ETW2 is generated from the sensor data SD2. A feature amount vector EFV3 corresponding to a time window ETW3 is generated from the sensor data SD2. On the basis of the learning model LM, an estimation label EL1, an estimation label EL2, an estimation label EL3, and so on are estimated respectively from the feature amount vector EFV1, the feature amount vector EFV2, the feature amount vector EFV3, and so on.

(Configuration of Labeling Device)

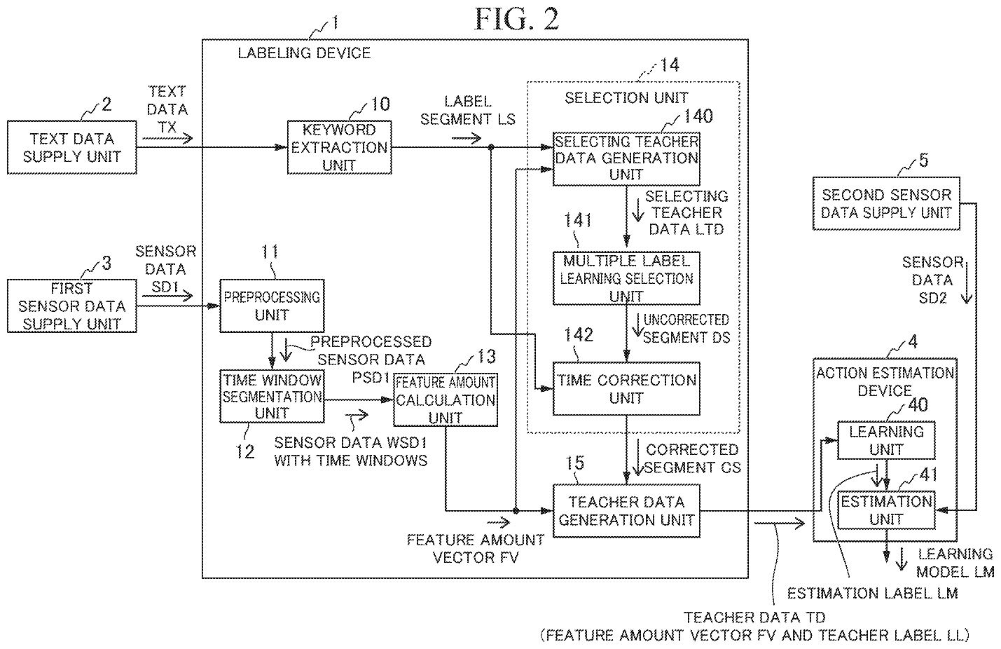

Next, a configuration of the labeling device 1 will be described with reference to FIG. 2. FIG. 2 is a view showing an example of a configuration of the labeling device 1 according to the present embodiment.

The labeling device 1 performs labeling of the feature amount vector FV extracted from the sensor data SD1 with the teacher label LL. The labeling device 1 generates the teacher data TD by labeling of the feature amount vector FV with the teacher label LL. Here, the labeling device 1 generates the teacher data TD from the text data TX supplied by a text data supply unit 2 and the sensor data SD1 supplied by a first sensor data supply unit 3. The labeling device 1 supplies the generated teacher data TD to an action estimation device 4.

The labeling device 1 includes a keyword extraction unit 10, a preprocessing unit 11, a time window segmentation unit 12, a feature amount calculation unit 13, a selection unit 14, and a teacher data generation unit 15.

The keyword extraction unit 10 acquires the text data TX supplied by the text data supply unit 2. The keyword extraction unit 10 selects the action keyword KA from the acquired text data TX. The keyword extraction unit 10 extracts the selected action keyword KA as the teacher label candidate LC. That is, as a candidate for a teacher label (teacher label candidate LC), the keyword extraction unit 10 extracts a keyword (action keyword KA) indicating an action of a subject included in the text data TX in which actions of a subject are recorded in a natural language text format.

Regarding the extracted teacher label candidate LC, when there are a plurality of teacher label candidates including a teacher label candidate LC1, a teacher label candidate LC2, and so on for one action, the keyword extraction unit 10 extracts the teacher label candidates LC fewer than the plurality of teacher label candidates including the teacher label candidate LC1, the teacher label candidate LC2, and so on.

For example, regarding the teacher label candidate LC1, the teacher label candidate LC2, and so on which have been extracted, when there are a teacher label candidate LCi, a teacher label candidate LCj, and a teacher label candidate LCk having a similar meaning or having relevance to each other for one action, the keyword extraction unit 10 integrates an action keyword KAi, an action keyword KAj, and an action keyword KAk having a similar meaning or having relevance to each other, of an action keyword KA1, an action keyword KA2, and so on which have been selected, in one integrated action keyword KAC1. The keyword extraction unit 10 extracts the integrated action keyword KAC1 as the teacher label candidate LC1. Here, the keyword extraction unit 10 integrates the action keyword KA1, the action keyword KA2, and so on which have been selected using any of techniques including morphological analysis, dependency analysis, and case frame analysis. That is, the keyword extraction unit 10 extracts the teacher label candidate LC1 using any of techniques including morphological analysis, dependency analysis, and case frame analysis.

When the action keyword KA1, the action keyword KA1, and so on having a similar meaning or having relevance to each other are integrated in the one integrated action keyword KAC1, the keyword extraction unit 10 may perform integration by associating the action keyword KA1, the action keyword KA2, and so on with an action class, for example. Specific examples of an action class include “sleep”, “meal”, “restroom”, “take a dose”, and “exercise”, for example. For example, the keyword extraction unit 10 integrates the action keyword KA1 “take medicine” and the action keyword KA2 “take a dose of a tablet” in the integrated action keyword KAC1 “take a dose”.

In the present embodiment, a case in which the keyword extraction unit 10 integrates the action keyword KA1, the action keyword KA2, and so on having a similar meaning or having relevance to each other in the one integrated action keyword KAC1 will be described, but the embodiment is not limited thereto. The keyword extraction unit 10 may extract an action keyword KA11, an action keyword KAl2, and so on having a similar meaning or having relevance to each other as the teacher label candidate LC1, the teacher label candidate LC1, and so on respectively as they stand.

In addition, in the present embodiment, a case in which the keyword extraction unit 10 performs integration by associating the action keyword KA1, the action keyword KA1, and so on having a similar meaning or having relevance to each other with an action class will be described, but the embodiment is not limited thereto. The keyword extraction unit 10 may integrate the action keyword KA1, the action keyword KA2, and so on by selecting one integrated action keyword KAC1 on the basis of a predetermined order, for example, from the action keyword KA1, the action keyword KA2, and so on having a similar meaning or having relevance to each other. For example, the keyword extraction unit 10 integrates the action keyword KA1 “take medicine” and the action keyword KA2 “take a dose of a tablet” in the integrated action keyword KAC1 “take medicine”.

The keyword extraction unit 10 selects a time keyword TK from the text data TX. Here, the time keyword TK is a keyword indicating a time. The keyword extraction unit 10 selects a beginning time keyword BTK from the selected time keyword TK. Moreover, the keyword extraction unit 10 selects an ending time keyword ETK corresponding to the selected beginning time keyword BTK. Here, the beginning time keyword BTK is a keyword indicating a candidate for a beginning time of an action of a subject. The ending time keyword ETK is a keyword indicating a candidate for an ending time of an action of a subject. The keyword extraction unit 10 extracts the selected beginning time keyword BTK as the beginning time information BT. The keyword extraction unit 10 extracts the selected ending time keyword ETK as the ending time information ET. That is, the keyword extraction unit 10 extracts the time information TI indicating a candidate for a time at which an action is performed from the acquired text data TX.

The keyword extraction unit 10 generates the label segment LS with a set of the extracted teacher label candidate LC, the extracted beginning time information BT, and the ending time information ET. There are cases in which the time sections IN of the label segments LS generated by the keyword extraction unit 10 overlap each other between a plurality of label segments including the label segment LS1, the label segment LS2, and so on. That is, according to a plurality of label segments including the label segment LS1, the label segment LS2, and so on generated by the keyword extraction unit 10, there are cases in which a plurality of teacher label candidates including the teacher label candidate LC1, the teacher label candidate LC2, and so on correspond to a certain time. One teacher label LL is selected from a plurality of teacher label candidates including the teacher label candidate LC1, the teacher label candidate LC2, and so on by the selection unit 14. The keyword extraction unit 10 supplies the generated label segment LS to the selection unit 14.

The preprocessing unit 11 acquires the sensor data SD1 supplied by the first sensor data supply unit 3. The preprocessing unit 11 performs preprocessing for the acquired sensor data SD1 and generates preprocessed sensor data PSD1. Here, preprocessing performed for the sensor data SD1 is processing of shaping the sensor data SD1 into a format allowing analysis for extracting a feature amount. The preprocessing unit 11 supplies the generated preprocessed sensor data PSD1 to the time window segmentation unit 12.

The time window segmentation unit 12 acquires the preprocessed sensor data PSD1 supplied by the preprocessing unit 11. The time window segmentation unit 12 allocates time windows (the time window TW1 to the time window TW3) to the acquired preprocessed sensor data PSD1 and generates sensor data WSD1 with time windows. The time window segmentation unit 12 supplies the generated sensor data WSD1 with time windows to the feature amount calculation unit 13.

The feature amount calculation unit 13 calculates the feature amount vectors FV (the feature amount vector FV1, the feature amount vector FV2, the feature amount vector FV3, and so on) for each of the allocated time windows from the sensor data WSD1 with time windows supplied by time window segmentation unit 12. The feature amount calculation unit 13 supplies the calculated feature amount vectors FV to the selection unit 14 and the teacher data generation unit 15.

The selection unit 14 performs processing of selecting one teacher label candidate LCi as the teacher label LL from a plurality of teacher label candidates including the teacher label candidate LC1, the teacher label candidate LC2, and so on. That is, the selection unit 14 selects the teacher label LL corresponding to the time information TI indicating a candidate for a time at which an action is performed from the teacher label candidates LC extracted by the keyword extraction unit 10. Here, the selection unit 14 selects one teacher label LL using selection learning ML14. The selection learning ML14 is supervised learning but differs from machine learning used for generating the learning model LM. The selection learning ML14 will be described below.

The selection unit 14 includes a selecting teacher data generation unit 140, a multiple label learning selection unit 141, and a time correction unit 142.

The selecting teacher data generation unit 140 generates selecting teacher data LTD. Here, the selecting teacher data LTD is teacher data used in the selection learning ML14. The selecting teacher data LTD differs from the teacher data TD generated by the teacher data generation unit 15. The selecting teacher data generation unit 140 generates the selecting teacher data LTD on the basis of the label segment LS supplied by the keyword extraction unit 10 and the feature amount vector FV supplied by the feature amount calculation unit 13. The selecting teacher data generation unit 140 supplies the generated selecting teacher data LTD to the multiple label learning selection unit 141.

The multiple label learning selection unit 141 selects one teacher label candidate LCj as an uncorrected teacher label ULL from a plurality of teacher label candidates LCi (i=1, 2, and so on). Here, an uncorrected teacher label ULL1 is a teacher label LL before processing of correcting a time lag, which will be described below. Here, the multiple label learning selection unit 141 selects one teacher label candidate LCj using the selecting teacher data LTD supplied by the selecting teacher data generation unit 140, and the selection learning ML14. That is, the selection unit 14 selects the uncorrected teacher label ULL using supervised learning from the teacher label candidates LCi (i=1, 2, and so on) extracted by the keyword extraction unit 10.

The multiple label learning selection unit 141 generates an uncorrected segment DS with a set of the selected uncorrected teacher label ULL, and the beginning time and the ending time regarding an action indicated by this uncorrected teacher label ULL. The multiple label learning selection unit 141 supplies the generated uncorrected segment DS to the time correction unit 142.

The time correction unit 142 corrects the beginning time and the ending time of the uncorrected segments DS supplied by the multiple label learning selection unit 141. Here, there are cases in which the uncorrected segments DS are fragmented or overlap each other regarding a time, and there is a need to correct the beginning time and the ending time in order to resolve fragmentation or overlapping regarding a time. The time correction unit 142 corrects the beginning time and the ending time of the uncorrected segment DS on the basis of the uncorrected segments DS supplied by the multiple label learning selection unit 141 and the label segment LS supplied by the keyword extraction unit 10. The time correction unit 142 selects the uncorrected teacher label ULL included in the uncorrected segment DS in which a time lag is corrected as the teacher label LL at each time included in the time section of this uncorrected segment DS. The time correction unit 142 generates a corrected segment CS with a set of the selected teacher label LL and the beginning time and the ending time of an action included in the uncorrected segment DS in which a time lag is corrected. The time correction unit 142 supplies the generated corrected segment CS to the teacher data generation unit 15.

The teacher data generation unit 15 generates a sample SM with a set of the feature amount vector FV supplied by the feature amount calculation unit 13, and the teacher label LL on the basis of the corrected segment CS supplied by the selection unit 14. Here, the teacher data generation unit 15 selects the corrected segment CS in which the time section IN of the corrected segment CS includes a time corresponding to the feature amount vector FV. The teacher data generation unit 15 forms a set of the teacher label LL included in the selected corrected segment CS and the feature amount vector FV.

The text data supply unit 2 supplies the text data TX in which actions are recorded using a natural language text format to the labeling device 1. For example, the text data supply unit 2 is a storage device in which the text data TX is stored.

The first sensor data supply unit 3 supplies the sensor data SD1 to the labeling device 1. For example, the first sensor data supply unit 3 is a sensor attached to the body of a subject. The first sensor data supply unit 3 may be a storage device storing the sensor data SD1. In addition, when the first sensor data supply unit 3 is a storage device, the first sensor data supply unit 3 may be configured to be integrated with the text data supply unit 2. The first sensor data supply unit 3 may be an arithmetic device for processing data measured by a sensor.

The action estimation device 4 includes a learning unit 40 and an estimation unit 41.

The learning unit 40 performs machine learning using the teacher data TD supplied by the labeling device 1. The learning unit 40 generates the learning model LM through machine learning.

The estimation unit 41 estimates the estimation label EL from the sensor data SD2 supplied by a second sensor data supply unit 5 on the basis of the learning model LM generated by the learning unit 40.

In the example shown in FIG. 2, the action estimation device 4 and the labeling device 1 are configured independently from each other, but the action estimation device 4 and the labeling device 1 may be configured integrally with each other.

The second sensor data supply unit 5 supplies the sensor data SD2 to the action estimation device 4.

(Learning Phase)

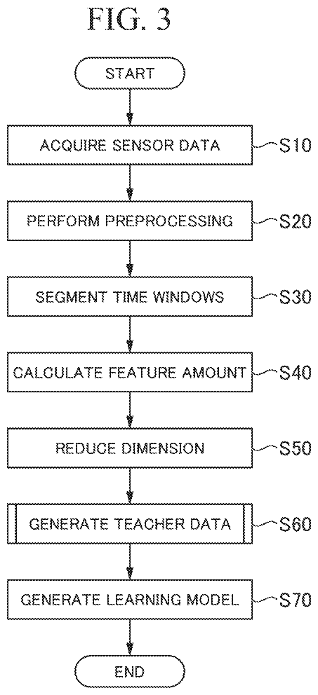

Processing of the labeling device 1 will be described. FIG. 3 is a view showing an example of learning processing of the labeling device 1 according to the present embodiment.

The preprocessing unit 11 acquires the sensor data SD1 supplied by the first sensor data supply unit 3 (Step S10). The preprocessing unit 11 performs preprocessing for the acquired sensor data SD1 (Step S20). The preprocessing unit 11 generates the preprocessed sensor data PSD1 as a result of preprocessing performed for the sensor data SD1. The preprocessing unit 11 supplies the generated preprocessed sensor data PSD1 to the time window segmentation unit 12.

The time window segmentation unit 12 acquires the preprocessed sensor data PSD1 supplied by the preprocessing unit 11. The time window segmentation unit 12 allocates the time windows TW (the time window TW1 to the time window TW3) to the preprocessed sensor data PSD1 supplied by the preprocessing unit 11 and generates the sensor data WSD1 with time windows. (Step S30). The time window segmentation unit 12 supplies the generated sensor data WSD1 with time windows to the feature amount calculation unit 13.

The feature amount calculation unit 13 acquires the sensor data WSD1 with time windows supplied by time window segmentation unit 12. The feature amount calculation unit 13 extracts one or more feature amounts for each time window TW from the acquired sensor data WSD1 with time windows (Step S40). The feature amount calculation unit 13 generates the feature amount vector FV from one or more feature amounts extracted from the sensor data WSD1 with time windows.

The feature amount calculation unit 13 performs processing of dimension reduction for the generated feature amount vector FV (Step S50). Here, processing of dimension reduction is processing of reducing the dimension of the feature amount vector FV through primary component analysis, for example. The feature amount calculation unit 13 supplies the feature amount vector FV subjected to processing of dimension reduction to the selecting teacher data generation unit 140 and the teacher data generation unit 15.

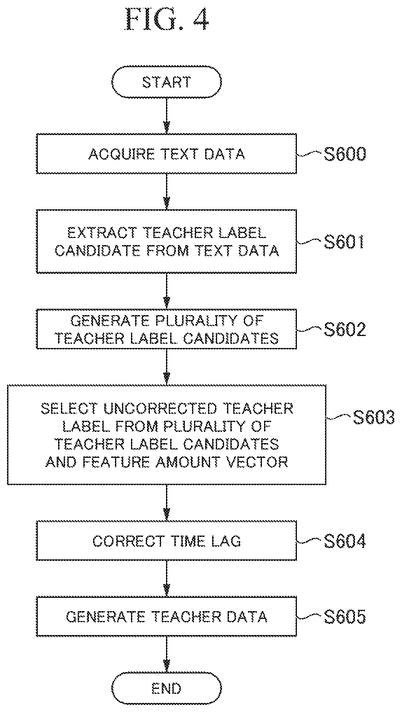

The teacher data generation unit 15 generates the teacher data TD on the basis of the feature amount vector FV and the corrected segment CS (Step S60). Processing in which the labeling device 1 generates the teacher data TD will be described below in detail with reference to FIG. 4. The teacher data generation unit 15 supplies the generated teacher data TD to the action estimation device 4.

The learning unit 40 of the action estimation device 4 generates the learning model LM on the basis of the teacher data TD supplied by the teacher data generation unit 15 (Step S70).

FIG. 4 is a view showing an example of processing of generating the teacher data TD of the labeling device 1 according to the present embodiment.

The keyword extraction unit 10 acquires the text data TX supplied by the text data supply unit 2 (Step S600).

The keyword extraction unit 10 selects the action keyword KA from the acquired text data TX (Step S601). The keyword extraction unit 10 selects the action keyword KA using a technique of known natural language processing. Known natural language processing includes morphological analysis, dependency analysis, case frame analysis, and the like. The keyword extraction unit 10 integrates the action keyword KA, of the selected action keywords KA, having a similar meaning or having relevance to each other in one integrated action keyword KAC. As the teacher label candidate LC, the keyword extraction unit 10 extracts the integrated action keyword KAC which has been integrated.

The keyword extraction unit 10 may use context analysis in addition to morphological analysis, dependency analysis, and case frame analysis. The keyword extraction unit 10 may estimate a referent such as a pronoun or a demonstrative or may complement an omitted noun phrase using anaphoric analysis as context analysis, for example.

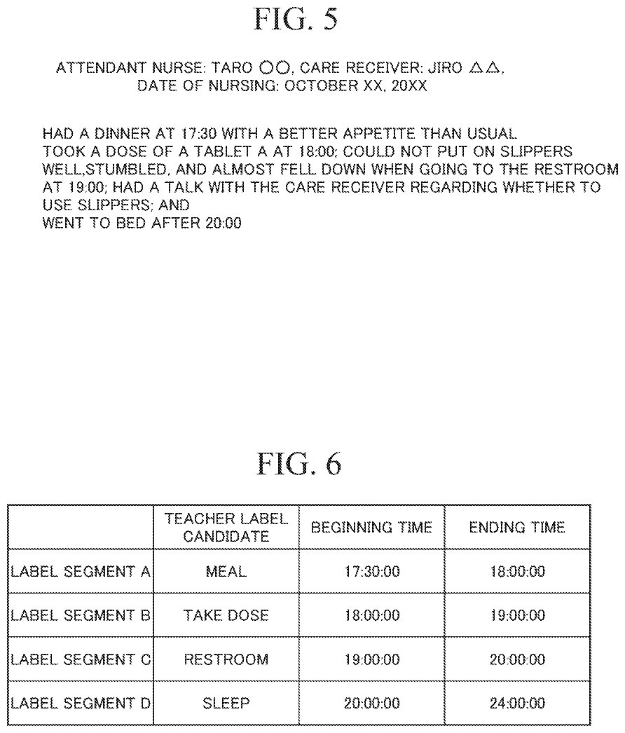

Here, with reference to FIGS. 5 and 6, a specific example in which the keyword extraction unit 10 selects the action keyword KA from the text data TX will be described.

FIG. 5 is a view showing an example of the text data TX according to the present embodiment. FIG. 6 is a view showing an example of a label candidate according to the present embodiment. As an example, the text data TX is an excerpt from sentences in a daily record of work recorded regarding nursing for a care receiver (subject) from the evening to the night of a certain day.

The keyword extraction unit 10 breaks down the text data TX into morphemes using morphological analysis. The keyword extraction unit 10 selects the time keywords TK from the morphemes which have been broken down.

For example, using morphological analysis, the keyword extraction unit 10 selects “17:30”, “18:00”, “19:00”, and “20:00” as the time keywords TK from the text data TX “Attendant nurse: Taro ∘∘, Care receiver: Jiro ΔΔ, Date of nursing: Oct. ______, 20______; Had a dinner at 17:30 with a better appetite than usual; Took a dose of a tablet A at 18:00; Could not put on slippers well, stumbled, and almost fell down when going to the restroom at 19:00; Had a talk with the care receiver regarding whether to use slippers; and Went to bed after 20:00”.

The keyword extraction unit 10 selects the beginning time keywords BTK from the selected time keywords TK. For example, the keyword extraction unit 10 selects “17:30”, “18:00”, “19:00”, and “20:00” as the beginning time keywords BTK from the time keywords TK “17:30”, “18:00”, “19:00”, and “20:00”.

The keyword extraction unit 10 selects the ending time keywords ETK corresponding to the selected beginning time keywords BTK from the selected time keywords TK. Here, as the ending time keywords ETK corresponding to the selected beginning time keywords BTK, the keyword extraction unit 10 selects the time keywords TK, of the selected time keywords TK, indicating new times next to times indicated by these beginning time keywords BTK.

In the example shown in FIG. 5, the keyword extraction unit 10 selects “18:00”, “19:00”, and “20:00” as the ending time keywords ETK respectively corresponding to the selected beginning time keywords BTK “17:30”, “18:00”, and “19:00” from the time keywords TK “17:30”, “18:00”, “19:00”, and “20:00”. However, since the ending time keyword ETK corresponding to the beginning time keyword BTK “20:00” is not selected from the text data TX shown in FIG. 5, the keyword extraction unit 10 selects “24:00” as the ending time keyword ETK corresponding to the beginning time keyword BTK “20:00”. Instead of “24:00”, the ending time keyword ETK corresponding to the beginning time keyword BTK “20:00” may be extracted from the text data TX of the next day and thereafter using morphological analysis.

The keyword extraction unit 10 extracts the selected beginning time keyword BTK as the beginning time information BT. The keyword extraction unit 10 extracts the selected ending time keyword ETK as the ending time information ET. For example, as the beginning time information BT and the ending time information ET, the keyword extraction unit 10 extracts “beginning time: 17:30” and “ending time: 18:00”, “beginning time: 18:00” and “ending time: 19:00”, “beginning time: 19:00” and “ending time: 20:00”, and “beginning time: 20:00” and “ending time: 24:00”.

In the example shown in FIG. 5, as shown in FIG. 6, the keyword extraction unit 10 generates a label segment A having “beginning time: 17:30” as the beginning time information BT and “ending time: 18:00” as the ending time information ET, for example. The keyword extraction unit 10 also generates a label segment B, a label segment C, and a label segment D in a similar manner.

Since the beginning time information BT and the ending time information ET are generated on the basis of the beginning time keyword BTK and the ending time keyword ETK selected from the text data TX, there are cases in which accuracy for generating the teacher data TD is not sufficient. The accuracy of a time indicated by the beginning time information BT and the ending time information ET is enhanced through the selection learning ML14 by the selection unit 14.

In the present embodiment, as the ending time keywords ETK, the keyword extraction unit 10 selects the time keywords TK indicating new times next to times indicated by the beginning time keywords BTK. Therefore, there is no time gap between the adjacent label segments LS regarding a time. As the ending time information ET, the keyword extraction unit 10 may extract a time after a predetermined time has elapsed from a beginning time indicated by the beginning time keyword BTK. When a time after a predetermined time has elapsed from a beginning time indicated by the beginning time keyword BTK is extracted as the ending time information ET, there may be a part in which the label segments LS overlap each other on a time axis.

The keyword extraction unit 10, in which typical necessary times for actions indicated by the teacher label candidates LC are set in advance, may correct the beginning time information BT or the ending time information ET regarding the label segments LS including these teacher label candidates LC.

Next, the keyword extraction unit 10 extracts the teacher label candidates LC from the text data TX.

The keyword extraction unit 10 selects the action keyword KA from a text used for selecting the beginning time keyword BTK and the ending time keyword ETK. Here, the keyword extraction unit 10 selects the action keyword KA using morphological analysis, dependency analysis, and case frame analysis.

In the example shown in FIG. 5, regarding the label segment A, the keyword extraction unit 10 selects “dinner” and “appetite” as the action keywords KA from the text “Had a dinner at 17:30 with a better appetite than usual” used for selecting the beginning time keyword BTK and the ending time keyword ETK.

Regarding the label segment B, the keyword extraction unit 10 selects “tablet A” and “took a dose” as the action keywords KA from the text “Took a dose of a tablet A at 18:00” used for selecting the beginning time keyword BTK and the ending time keyword ETK.

Regarding the label segment C, the keyword extraction unit 10 selects “restroom”, “going”, “slippers”, and “could not put on” as the action keywords KA from the text “Could not put on slippers well, stumbled, and almost fell down when going to the restroom at 19:00; Had a talk with the care receiver regarding whether to use slippers” used for selecting the beginning time keyword BTK and the ending time keyword ETK.

Regarding the label segment D, the keyword extraction unit 10 selects “went to bed” as the action keyword KA from the text “Went to bed after 20:00” used for selecting the beginning time keyword BTK and the ending time keyword ETK.

In processing of selecting the action keyword KA, the keyword extraction unit 10 selects a sentence or a part related to an action of a subject from the selected text. For example, the keyword extraction unit 10 selects “Could not put on slippers well, stumbled, and almost fell down when going to the restroom at 19:00” as a part related to an action of a subject from the text “Could not put on slippers well, stumbled, and almost fell down when going to the restroom at 19:00; Had a talk with the care receiver regarding whether to use slippers”.

When a sentence or a part related to an action of a subject is selected from the selected text, the keyword extraction unit 10 may use a dictionary database (not shown). When a sentence or a part related to an action of a subject is selected from the selected text, the keyword extraction unit 10 may adopt, as a selection target, only a sentence or a part including the action keyword KA which coincides with a keyword registered in a dictionary database in advance or the action keyword KA related to an action class. In addition, when a sentence or a part related to an action of a subject is selected from the selected text, the keyword extraction unit 10 may adopt, as a selection target, only a sentence or a part including the action keyword KA which has been selected in the past as the action keyword KA related to a keyword registered in a dictionary database in advance.

For each label segment LS, the keyword extraction unit 10 integrates the action keyword KA, of the selected action keywords KA, having a similar meaning or having relevance to each other in the integrated action keyword KAC. Here, the keyword extraction unit 10 integrates the action keyword KA corresponding to an action class. An action class may be registered in a dictionary database in advance.

In the example shown in FIG. 5, the keyword extraction unit 10 integrates “dinner” and “appetite” as “meal”. The keyword extraction unit 10 integrates “tablet A” and “took a dose” as “take a dose”. The keyword extraction unit 10 integrates “restroom”, “going”, “slippers”, “could not put on”, “stumbled”, and “fell down” as “restroom”.

When no action class corresponding to the selected action keyword KA is present, the keyword extraction unit 10 may integrate the action keyword KA in the integrated action keyword KAC by newly generating an action class and causing the selected action keyword KA to correspond to the generated action class.

The keyword extraction unit 10 extracts the selected action keyword KA as the teacher label candidate LC through the processing described above.

As described above, the keyword extraction unit 10, in which typical necessary times for respective actions indicated by the teacher label candidates LC are set in advance, may correct the time information TI (the beginning time information BT and the ending time information ET) to be in a set with each of the teacher label candidates LC. In a case in which the keyword extraction unit 10 corrects the time information TI (the beginning time information BT and the ending time information ET), when the necessary time for “take a dose” is set to three minutes in the keyword extraction unit 10, for example, the keyword extraction unit 10 may correct the ending time indicated by the ending time information ET of the label segment B from “19:00:00” to “18:03:00”. In addition, when the necessary time for “restroom” is set to five minutes in the keyword extraction unit 10, the keyword extraction unit 10 may correct the ending time indicated by the ending time information ET of the label segment C from “20:00:00” to “19:05:00”.

In the present embodiment, a case in which the time keywords TK and the action keywords KA are indicated in the text data TX has been described with an example of a daily record of nursing work. However, details of daily work may be collectively recorded in the text data TX. The keyword extraction unit 10 may generate the time information TI (the beginning time information BT and the ending time information ET) by extracting a noun allowing estimation of a time instead of the time keyword TK. For example, the keyword extraction unit 10 may generate the beginning time information BT “beginning time: 17:00” from a noun such as “evening”.

Returning to FIG. 4, description of processing of generating the teacher data TD of the labeling device 1 will be continued.

The keyword extraction unit 10 supplies the generated label segment LS to the selecting teacher data generation unit 140 and the time correction unit 142. The selecting teacher data generation unit 140 acquires the label segment LS supplied by the keyword extraction unit 10. The selecting teacher data generation unit 140 acquires the feature amount vector FV supplied by the feature amount calculation unit 13.

The selecting teacher data generation unit 140 generates the selecting teacher data LTD from the feature amount vector FV and the label segment LS. The selecting teacher data generation unit 140 generates a plurality of teacher label candidates LCi (i=1, 2, and so on) at a certain time (Step S602). The selecting teacher data generation unit 140 generates the selecting teacher data LTD by forming a set with each of the plurality of teacher label candidates LCi (i=1, 2, and so on) generated at a certain time and the feature amount vector FV corresponding to this time. That is, in the selecting teacher data LTD, one feature amount vector FV corresponding to this time corresponds to each of a plurality of teacher label candidates LCi (i=1, 2, and so on) at a certain time.

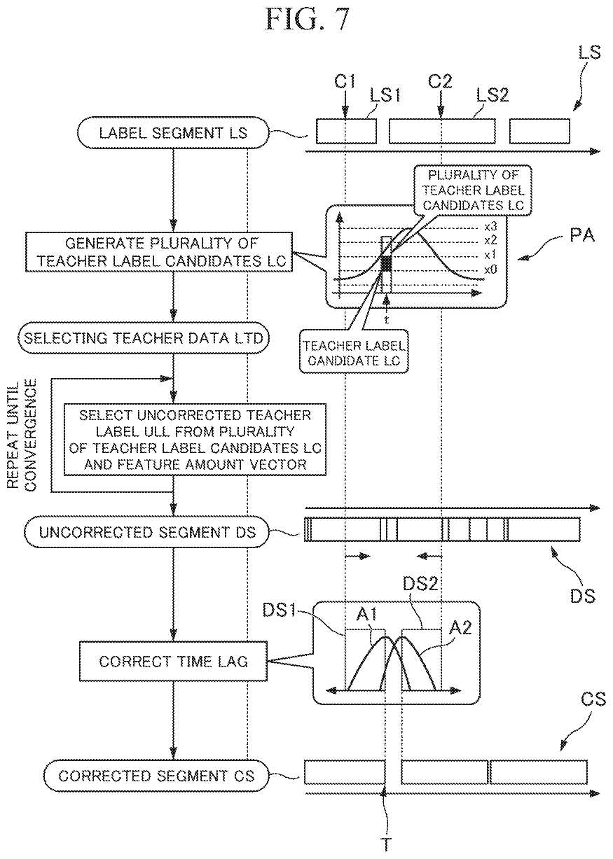

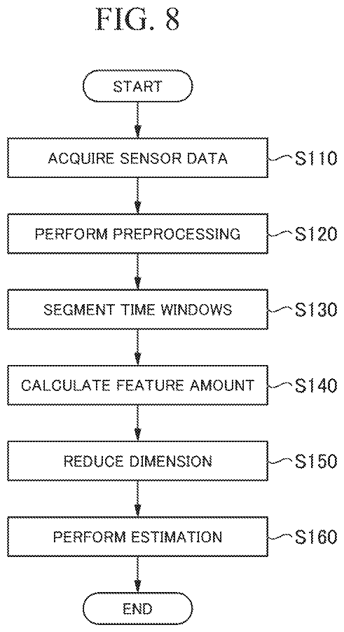

Here, an action indicated by a plurality of teacher label candidates LCi (i=1, 2, and so on) is any of the actions indicated by the teacher label candidate LC1, the teacher label candidate LC2, and so on respectively included in the label segment LS1, the label segment LS2, and so on. The selecting teacher data generation unit 140 decides the ratio of a plurality of teacher label candidates LCi (i=1, 2, and so on) to be generated on the basis of a teacher label candidate probability distribution PA. That is, a plurality of teacher label candidates LCi (i=1, 2, and so on) generated by the selecting teacher data generation unit 140 can be obtained by reproducing the teacher label candidate LC1, the teacher label candidate LC2, and so on respectively included in the label segment LS1, the label segment LS2, and so on at a ratio on the basis of the teacher label candidate probability distribution PA. Here, the teacher label candidate probability distribution PA will be described with reference to FIG. 7.

FIG. 7 is a view showing an example of an overview of processing of selecting the teacher label candidate LC of the selection unit 14 according to the present embodiment. The teacher label candidate probability distribution PA is a probability distribution obtained by adding a probability distribution of the teacher label candidates LC for each action indicated by the teacher label candidate LC for a common action. A probability distribution for each action indicated by the teacher label candidate LC is a Gaussian distribution, for example. A standard deviation of this Gaussian distribution is proportional to the length of the time section IN of the label segment LS. The average of this Gaussian distribution is a median time of the time section IN.

That is, the ratio of the teacher label candidate LC included in the selecting teacher data LTD is decided on the basis of the teacher label candidate probability distribution PA which is a probability distribution generated from the time information TI (the beginning time information BT and the ending time information ET) extracted by the keyword extraction unit 10. When the ratio of a probability distribution for each action indicated by the teacher label candidate LC at a certain time t increases, the ratio of this teacher label candidate LC increases in a plurality of teacher label candidates LCi (i=1, 2, and so on) generated by the selecting teacher data generation unit 140.

The teacher label candidate probability distribution PA is normalized.

Returning to FIG. 4, description of processing of generating the teacher data TD of the labeling device 1 will be continued.

The selecting teacher data generation unit 140 supplies the generated selecting teacher data LTD to the multiple label learning selection unit 141.

The multiple label learning selection unit 141 selects the teacher label candidate LC as the uncorrected teacher label ULL from the selecting teacher data LTD supplied by the selecting teacher data generation unit 140 (the feature amount vector FV and a plurality of teacher label candidates LCi (i=1, 2, and so on)) (Step 0). The multiple label learning selection unit 141 selects the uncorrected teacher label ULL and the beginning time and the ending time regarding an action indicated by this uncorrected teacher label ULL from the selecting teacher data LTD using the selection learning ML14.

Here, the selection learning ML14 is machine learning using the selecting teacher data LTD generated by the selecting teacher data generation unit 140. That is, the selection learning ML14 is learning using, as teacher data, data in which feature amounts extracted from data detected by a sensor detecting a predetermined amount changing in accordance with an action of a subject and a plurality of teacher label candidates LCi (i=1, 2, and so on) are associated with each other for each time.

The multiple label learning selection unit 141 calculates a first probability distribution from the selecting teacher data LTD through machine learning. Here, the first probability distribution is a probability distribution indicating a probability that an action indicated by the teacher label candidate LCj at a time corresponding to the feature amount vector FV is a certain action when this feature amount vector FV is applied.

The multiple label learning selection unit 141 calculates a second probability distribution on the basis of the calculated first probability distribution. Here, the second probability distribution is a probability distribution of an action indicated by the teacher label candidate LCj at a time corresponding to this feature amount vector FV when the feature amount vector FV included in the selecting teacher data LTD is applied.

The multiple label learning selection unit 141 generates a plurality of teacher label candidates LC2i (i=1, 2, and so on) at a certain time. Here, the multiple label learning selection unit 141 decides the ratio of an action indicated by the plurality of generated teacher label candidates LC2i (i=1, 2, and so on) on the basis of the calculated second probability distribution.

The multiple label learning selection unit 141 generates second selecting teacher data LTD2 by forming a set with each of the plurality of teacher label candidates LC2i (i=1, 2, and so on) generated at a certain time and the feature amount vector FV corresponding to this time. The multiple label learning selection unit 141 calculates the first probability distribution using the generated second selecting teacher data LTD2 instead of the selecting teacher data LTD. The multiple label learning selection unit 141 repeats the foregoing processing until the second probability distribution is converged.

The multiple label learning selection unit 141 selects, as the uncorrected teacher label ULL for each time, a teacher label candidate LC2j in which the second probability distribution becomes the largest from the teacher label candidates LC2i (i=1, 2, and so on) with respect to each of the feature amount vectors FV on the basis of the converged second probability distribution. Here, the multiple label learning selection unit 141 selects one uncorrected teacher label ULL for each time.

Here, the uncorrected teacher label ULL selected by the multiple label learning selection unit 141 is applied to each time. The multiple label learning selection unit 141 determines the beginning time and the ending time of an action indicated by the uncorrected teacher label ULL by determining a place at which the uncorrected teacher labels ULL indicating actions different from each other are adjacent to each other when the uncorrected teacher labels ULL are enumerated for each time. The multiple label learning selection unit 141 selects the beginning time and the ending time of an action on the basis of the determination results.

The multiple label learning selection unit 141 generates the uncorrected segment DS with a set of the selected uncorrected teacher label ULL and the beginning time and the ending time of an action which have been determined. The multiple label learning selection unit 141 supplies the generated uncorrected segment DS to the time correction unit 142.

The time correction unit 142 acquires the uncorrected segments DS supplied by the multiple label learning selection unit 141. The time correction unit 142 acquires the label segment LS supplied by the keyword extraction unit 10.

There are cases in which the uncorrected segments DS are fragmented regarding a period of time during which one action continues and deviate from the beginning time and the ending time of an actual action. The time correction unit 142 corrects the time lag between the uncorrected segments DS (Step S604). Here, correction of a time lag between the uncorrected segments DS is correction of the beginning time and the ending time included in the uncorrected segments DS.

Here, with reference to FIG. 7 again, a case in which the time correction unit 142 corrects a time lag between an uncorrected segment DS1 and an uncorrected segment DS2 adjacent to this uncorrected segment DS1 will be described.

The time correction unit 142 generates an action amount corresponding to a certain time interval. Here, an action amount corresponding to a certain time interval is an amount obtained by counting the uncorrected teacher label ULL at each time in a certain time interval for each action indicated by the uncorrected teacher label ULL. The time correction unit 142 uses a generated action amount as likelihood. Here, the likelihood is the likelihood that a certain time interval is included between the time sections IN of the uncorrected segments DS.

The time correction unit 142 calculates an action amount corresponding to the time interval from a time C1 corresponding to the median point of the time section IN1 of the label segment LS1 to a certain time T.

The time correction unit 142 determines the time T at which the action amount becomes the largest when the time T is changed in a section between the time C1 and a time C2 corresponding to the median point of the time section 1N2 of the label segment LS2.

The time correction unit 142 determines whether the determined time T is adopted as the beginning time or the ending time of the uncorrected segment DS1 in accordance with the order of the time C1 and the time C2 on the time axis. When the time C2 is behind the time C1 on the time axis, the time correction unit 142 adopts the determined time T as the ending time of the uncorrected segment DS1. When the time C2 is ahead of the time C1 on the time axis, the time correction unit 142 adopts the determined time T as the beginning time of the uncorrected segment DS1.

Here, it is assumed that the beginning time of the uncorrected segment DS1 is ahead of the ending time of the uncorrected segment DS2 on the time axis. When the uncorrected segment DS1 and the uncorrected segment DS2 overlap each other on the time axis, the time correction unit 142 adopts the median point of the overlapping time sections as the ending time of the uncorrected segment DS1 and the beginning time of the uncorrected segment DS2. When there is a gap between the uncorrected segment DS1 and the uncorrected segment DS2 on the time axis, the time correction unit 142 adopts the median point of the gap as the ending time of the uncorrected segment DS1 and the beginning time of the uncorrected segment DS2.

Returning to FIG. 4, description of processing of generating the teacher data TD of the labeling device 1 will be continued.

The time correction unit 142 selects the uncorrected teacher label ULL included in the uncorrected segment DS in which a time lag is corrected as the teacher label LL at each time included in the time section of this uncorrected segment DS. The time correction unit 142 generates the corrected segment CS with a set of the selected teacher label LL and the beginning time and the ending time of an action included in the uncorrected segment DS in which a time lag is corrected. The time correction unit 142 supplies the generated corrected segment CS to the teacher data generation unit 15.

The teacher data generation unit 15 generates the teacher data (Step S605). The teacher data generation unit 15 acquires the corrected segment CS supplied by the time correction unit 142. The teacher data generation unit 15 acquires the feature amount vector FV supplied by the feature amount calculation unit 13. The teacher data generation unit 15 generates the sample SM with a set of the acquired feature amount vector FV and the teacher label LL on the basis of the acquired corrected segment CS. Here, the teacher data generation unit 15 selects the corrected segment CS in which the time section IN of the corrected segment CS includes a time corresponding to the feature amount vector FV. The teacher data generation unit 15 forms a set of the teacher label LL included in the selected corrected segment CS and the feature amount vector FV.

The teacher data generation unit 15 generates the teacher data TD from the sample SM1, the sample SM2, and so on at respective times. The teacher data generation unit 15 supplies the generated teacher data TD to the action estimation device 4.

In the present embodiment, a case in which the time correction unit 142 corrects the time lag between the uncorrected segments DS and selects the teacher label LL is described, but the embodiment is not limited thereto. Processing of correcting the time lag between the uncorrected segments DS may be omitted, and the multiple label learning selection unit 141 may select the uncorrected teacher label ULL included in the generated uncorrected segment DS as the teacher label LL. When the multiple label learning selection unit 141 selects the teacher label LL, the multiple label learning selection unit 141 supplies the uncorrected segment DS to the teacher data generation unit 15 as the corrected segment CS.

(Estimation Phase)

FIG. 7 is a view showing an example of estimation processing of the action estimation device 4 according to the present embodiment. The processing shown in FIG. 7 is executed after the learning model LM is generated through the processing shown in FIG. 3.

The processing of each of Steps S110, S120, S130, S140, and S150 is similar to the processing of each of Steps S10, S20, S30, S40, and S50 in FIG. 3, and therefore description thereof will be omitted.

The estimation unit 41 estimates the estimation label EL from the sensor data SD2 supplied by the second sensor data supply unit 5 on the basis of the learning model LM generated by the learning unit 40 (Step S160). The estimation unit 41 causes a display device (not shown) to display the estimated estimation label EL or causes a storage device (not shown) to store the estimated estimation label EL.

(Summary)

As described above, the labeling device 1 according to the present embodiment is a labeling device for teacher data used in learning during machine learning for estimating a time series of actions from data detected by a sensor and includes the keyword extraction unit 10 and the selection unit 14.

The keyword extraction unit 10 extracts, as teacher label candidates LC which are candidates for teacher labels, the action keyword KA indicating actions included in the text data TX in which the actions are recorded in a natural language text format.

The selection unit 14 selects the teacher labels LL corresponding to the time information TI indicating candidates for times at which actions are performed from the teacher label candidates LC extracted by the keyword extraction unit 10.

According to this configuration, the labeling device 1 according to the present embodiment can select the teacher labels LL from the teacher label candidates LC extracted from the text data TX. Therefore, labeling of the teacher data TD used in learning during machine learning with the teacher labels LL can be simply performed.

In addition, the keyword extraction unit 10 extracts the time information TI from the text data TX.

According to this configuration, the labeling device 1 according to the present embodiment can enhance the accuracy of the beginning time or the ending time regarding an action indicated by the teacher label LL. Therefore, it is possible to enhance the prediction accuracy of the learning model LM learned using the teacher data TD generated by the labeling device 1.

In addition, regarding the extracted teacher label candidate LC, when there are a plurality of teacher label candidates (the teacher label candidate LC1, the teacher label candidate LC2, and so on) for one action, the keyword extraction unit 10 extracts the teacher label candidates LC fewer than the plurality of teacher label candidates (the teacher label candidate LC1, the teacher label candidate LC2, and so on).

According to this configuration, the labeling device 1 according to the present embodiment can extract the teacher label candidate LC by integrating synonyms. Therefore, it is possible to enhance the efficiency when the teacher label candidate LC is extracted from the text data TX compared to when no synonym is integrated.

In addition, the keyword extraction unit 10 extracts the teacher label candidate LC using any of techniques including morphological analysis, dependency analysis, and case frame analysis.

According to this configuration, the labeling device 1 according to the present embodiment can use morphological analysis, dependency analysis, or case frame analysis when the teacher label candidate LC is extracted from the text data TX. Therefore, it is possible to enhance the prediction accuracy of the learning model LM learned using the teacher data TD generated by the labeling device 1 compared to when any of techniques including morphological analysis, dependency analysis, and case frame analysis is not used.

In addition, the selection unit 14 selects the teacher label LL using supervised learning (selection learning ML14) from the teacher label candidates LC extracted by the keyword extraction unit 10.

According to this configuration, the labeling device 1 according to the present embodiment can enhance the accuracy of selecting the teacher label LL from the teacher label candidates LC extracted from the text data TX. Therefore, it is possible to enhance the prediction accuracy of the learning model LM learned using the teacher data TD generated by the labeling device 1.

The labeling device 1 according to the present embodiment can be applied to action recognition for nurses or patients in hospitals. Results of the action recognition can be utilized for efficient and optimal nursing, prediction of the condition of a patient, and the like. In addition, the labeling device 1 according to the present embodiment may be applied to action recognition for care workers or care receivers in nursing facilities. Results of the action recognition can be utilized for efficient and optimal nursing, grasping the state or prediction of the condition of a care receiver, and the like.

In the embodiment described above, a case in which the keyword extraction unit 10 extracts a candidate for the beginning time or a candidate for the ending time of an action of a subject from the text data TX has been described. However, regarding a method for extracting a candidate for the beginning time or a candidate for the ending time of an action of a subject, a candidate therefor may be extracted from other than the text data TX. For example, a candidate for the beginning time or a candidate for the ending time of an action of a subject may be extracted on the basis of information at a time when the text data TX is prepared.

In the embodiment described above, regarding a method for calculating the feature amount vectors FV at certain time intervals from the preprocessed sensor data PSD1, a case in which the time window segmentation unit 12 allocates the time windows (the time window TW1 to the time window TW3) to the preprocessed sensor data PSD1 and generates the sensor data WSD1 with time windows has been described. However, the method for calculating the feature amount vectors FV at certain time intervals from the preprocessed sensor data PSD1 is not limited thereto. For example, a known change-point detection algorithm or a known hidden Markov model may be used as the method for calculating the feature amount vectors FV at certain time intervals from the preprocessed sensor data PSD1.

In the embodiment described above, a case in which the selection unit 14 selects the teacher label LL using supervised learning (selection learning ML14) from candidates for a teacher label (teacher label candidate LC) extracted by the keyword extraction unit 10 has been described. However, the selection unit 14 may select a teacher label using positional information or an individual ID of a subject in addition to the time information TI indicating a candidate for a time at which an action is performed during processing of selecting candidates for a teacher label (teacher label candidate LC) from candidates for a plurality of teacher labels (the teacher label candidate LC1, the teacher label candidate LC2, and so on).

In addition, regarding the method in which the selection unit 14 selects candidates for a teacher label (teacher label candidate LC), a method other than the supervised learning (selection learning ML14) described in the embodiment may be used.

For example, the selection unit 14 may select the teacher label candidate LC1 extracted from the text data TX by the keyword extraction unit 10 on the basis of history information indicating an extraction frequency of the teacher label candidate LC1 in the past. For example, the selection unit 14 causes the teacher label candidate LC1 extracted by the keyword extraction unit 10 in the past to be stored in a database as history information and calculates the extraction frequency of the teacher label candidate LC1 on the basis of this history information. Here, the teacher label candidate LC1 extracted by the keyword extraction unit 10 in the past is the teacher label candidate LC1 extracted before a timing at which the keyword extraction unit 10 performs processing of extracting the teacher label candidate LC1. In addition, the selection unit 14 may calculate the extraction frequency of the teacher label candidate LC1 from the teacher label candidate LC1 extracted from the text data TX instead of calculating the extraction frequency thereof on the basis of history information stored in a database.

Part of the labeling device 1 and the action estimation device 4 in the embodiment described above, for example, the keyword extraction unit 10, the preprocessing unit 11, the time window segmentation unit 12, the feature amount calculation unit 13, the selection unit 14, the teacher data generation unit 15, the learning unit 40, or the estimation unit 41 may be realized by a computer. In such a case, the part may be realized by recording a program for realizing this control function in a computer readable recording medium and causing a computer system to read and execute the program recorded in this recording medium. It is assumed that the aforementioned “computer system” is a computer system built into the labeling device 1 and the action estimation device 4 and includes hardware such as an OS and peripheral equipment. In addition, “a computer readable recording medium” indicates a portable medium such as a flexible disk, a magneto-optical disc, a ROM, or a CD-ROM, or a storage device such as a hard disk built into a computer system. Moreover, “a computer readable recording medium” may include a medium which dynamically holds a program for a short period of time such as a communication line in a case in which a program is transmitted via a network such as the internet or a communication channel such as a telephone line, or a medium which holds a program for a certain period of time such as a volatile memory inside a computer system which becomes a server or a client in such a case. In addition, the foregoing program may be a program for realizing some of the functions described above. Moreover, it may be a program which can realize the functions described above in combination with a program which has already been recorded in a computer system.

In addition, a part or all of the labeling device 1 and the action estimation device 4 in the embodiment described above may be realized as an integrated circuit such as a large scale integration (LSI). Each of the functional blocks of the labeling device 1 and the action estimation device 4 may be individually constituted as a processor, or part or all of the functional blocks thereof may be integrally constituted as a processor. In addition, a technique for an integrated circuit is not limited to an LSI and may be realized with a dedicated circuit or a general-purpose processor. In addition, when a technology for an integrated circuit substituting for an LSI appears in accordance with progress in a semiconductor technology, an integrated circuit of the technology may be used.

Hereinabove, an embodiment of this invention has been described in detail with reference to the drawings. However, specific configurations are not limited to those described above, and various design changes or the like can be performed within a range not departing from the gist of this invention.

### REFERENCE SIGNS LIST

1 Labeling device

2 Text data supply unit

3 First sensor data supply unit

4 Action estimation device

40 Learning unit

41 Estimation unit

5 Second sensor data supply unit

10 Keyword extraction unit

11 Preprocessing unit

12 Time window segmentation unit

13 Feature amount calculation unit

14 Selection unit

140 Selecting teacher data generation unit

141 Multiple label learning selection unit

142 Time correction unit

15 Teacher data generation unit

TX Text data

SD1, SD2 Sensor data

TD Teacher data

LS Label segment

PSD1 Preprocessed sensor data

WSD1 Sensor data with time window

FV Feature amount vector

LTD Selecting teacher data

DS Uncorrected segment

CS Corrected segment

1. A labeling device for teacher data used in learning during machine learning for estimating a time series of actions from data detected by a sensor, the labeling device comprising:
a keyword extraction unit that extracts, as teacher label candidates which are candidates for teacher labels, action keywords indicating the actions included in text data in which the actions are recorded in a natural language text format; and
a selection unit that selects the teacher labels corresponding to time information indicating candidates for times at which the actions are performed from the teacher label candidates extracted by the keyword extraction unit.

2. The labeling device according to claim 1,
wherein the keyword extraction unit extracts the time information from the text data.

3. The labeling device according to claim 1,
wherein when there are a plurality of the teacher label candidates for one of the actions regarding the extracted teacher label candidates, the keyword extraction unit extracts the teacher label candidates fewer than the plurality of the teacher label candidates.

4. The labeling device according to claim 3,
wherein the keyword extraction unit extracts the teacher label candidates using any of techniques including morphological analysis, dependency analysis, and case frame analysis.

5. The labeling device according to claim 1,
wherein the selection unit selects the teacher labels from the teacher label candidates extracted by the keyword extraction unit using supervised learning.

6. A labeling method for teacher data used in learning during machine learning for estimating a time series of actions from data detected by a sensor, the labeling method comprising:
a keyword extracting process of extracting, as teacher label candidates which are candidates for teacher labels, action keywords indicating the actions included in text data in which the actions are recorded in a natural language text format; and
a selecting process of selecting the teacher labels corresponding to time information indicating candidates for times at which the actions are performed from the teacher label candidates extracted in the keyword extracting process.

7. A program for causing a computer, which performs labeling of teacher data used in learning during machine learning for estimating a time series of actions from data detected by a sensor, to execute
a keyword extracting step of extracting, as teacher label candidates which are candidates for teacher labels, action keywords indicating the actions included in text data in which the actions are recorded in a natural language text format, and
a selecting step of selecting the teacher labels corresponding to time information indicating candidates for times at which the actions are performed from the teacher label candidates extracted in the keyword extracting step.
